(19) United States
(12) Patent Application Publication
(10) Pub. No.: US 2013/0197925 A1
(43) Pub. Date: Aug. 1, 2013

(54) BEHAVIORAL CLUSTERING FOR REMOVING OUTLYING HEALTHCARE PROVIDERS

(71) Applicant: Optumlnsight, Inc., Eden Prairie, MN (US)

(72) Inventor: Joseph Blue, Encinitas, CA (US)

(73) Assignee: Optumlnsight, Inc., Eden Prairie, MN (US)

(21) Appl. No.: 13/751,723

(22) Filed: Jan. 28, 2013

Related U.S. Application Data
(60) Provisional application No. 61/593,180, filed on Jan. 31, 2012.

(51) Int. Cl. G06F 19/00; G06Q 50/22

(52) U.S. Cl. CPC G06F 19/32; G06Q 50/22
USPC 705/2

(57) ABSTRACT

Behavioral clustering of providers may be used to identify outliers of a group of providers. Groups of healthcare providers may be built based on analysis of clinical information related to medical treatments. A plurality of subgroups of healthcare providers may be constructed in the groups, based on analysis of non-clinical information related to demographical information. First-level outlier healthcare providers may be removed from a particular group of healthcare providers, and second-level outlier healthcare providers may be removed from a particular subgroup of healthcare providers. The second-level outlier healthcare providers removed from the particular subgroup may remain in a group that contains the particular subgroup.

### CROSS REFERENCE TO RELATED APPLICATIONS

This application claims the benefit of U.S. Provisional Application No. 61/593,180 to Joseph Blue entitled “Systems and Methods for Behavioral Clustering” and filed Jan. 31, 2012, which is hereby incorporated by reference.

### BACKGROUND OF THE DISCLOSURE

1. Field of the Disclosure

This disclosure relates to systems and methods for behavioral clustering and more particularly relates to clustering healthcare providers into behavioral groups for behavioral inferences.

2. Description of the Related Art

Healthcare companies usually maintain a large database of healthcare data. The healthcare data can be utilized in many ways, such as analyzing the behavior of patients with certain diseases, analyzing the costs of a certain treatment provided by different healthcare providers, and analyzing the effectiveness of a certain treatment.

Another utilization of healthcare data is to analyze various behavior of healthcare providers, such as to identify abnormality in healthcare provider behaviors when compared to the cohort, which may be used for fraud detection. Conventional fraud detection depends on an inference drawn between a healthcare provider and his peer group to identify illogical or unlikely behavior, where the specialty of a healthcare provider is used to create the peer group. However, deriving peer groups based on specialties has numerous limitations and is not reliable. For example, specialties are self-reported and do not always reflect behavior. Furthermore, peer groups derived from specialties do not allow a user to control the size of the peer group. As a consequence, this approach makes outlier or anomaly detection of healthcare providers based on behavior extremely difficult due to heterogeneity among specialties.

### SUMMARY OF THE DISCLOSURE

This disclosure presents systems and methods for deriving peer groups of healthcare providers based on data-driven mathematical algorithms, where healthcare providers in the same group are assumed to have similar behaviors. Inferences drawn between a particular healthcare provider and his/her peers in the same group may be used to identify illogical or unlikely behavior of the particular healthcare provider. In the disclosed methods, peer groups may be defined through mathematical distances of observed data that include clinical and non-clinical information. The present disclosure may allow healthcare provider membership in a peer group to be agnostic of specialty. The present disclosure may also allow a user to control the size of a peer group through parameters and collapsing techniques. Moreover, healthcare providers who do not fit into any group or any subgroups of groups may be identified and removed from a group or subgroup of a group and not penalized for being unique. The present disclosure may allow unclassifiable providers that are truly unique healthcare providers do not pollute the existing groups, and therefore make the resulting inferences stronger.

Embodiments of methods for deriving healthcare provider groups are presented. In one embodiment, the method includes receiving a dataset for a plurality of healthcare providers where the dataset includes clinical and non-clinical information for each of the plurality of healthcare providers. In one embodiment, the method includes building from the plurality of healthcare providers a plurality of groups of healthcare providers based on analysis of the received clinical information related to medical treatments, and removing from a particular group of healthcare providers of the plurality of groups one or more healthcare providers determined to be outliers of the particular group. According to an embodiment, the method further includes constructing, within the plurality of groups of healthcare providers, a plurality of subgroups of healthcare providers based on analysis of the received non-clinical information related to demographical information. In an embodiment, the method also includes removing from a particular subgroup of healthcare providers of the plurality of subgroups one or more healthcare providers determined to be outliers of the particular subgroup.

In one embodiment, the method further includes identifying one or more first-level outlier healthcare providers from the particular group of healthcare providers, where the one or more first-level outlier healthcare providers are of a significant mathematical distance from a centroid of the particular group, and removing the one or more first-level outlier healthcare providers from the particular group. The method also includes identifying one or more second-level outlier healthcare providers from the particular subgroup of healthcare providers, where the one or more second-level outlier healthcare providers are of a significant mathematical distance from a centroid of the particular subgroup, and removing the one or more second-level outlier healthcare providers from the particular subgroup. In one embodiment, the second-level outlier healthcare providers removed from the particular subgroup remain in a group of the plurality of groups that contains the particular subgroup.

In one embodiment, the method includes defining a clinical descriptor, based on the received clinical information, for each of the plurality of healthcare providers, where each clinical descriptor comprises a vector of one or more variables, and evaluating one or more mathematical distances between multiple clinical descriptors. The method also includes defining a non-clinical descriptor, based on the received non-clinical information, for each of the plurality of healthcare providers, where each non-clinical descriptor comprises a vector of one or more variables, and evaluating one or more mathematical distances between multiple non-clinical descriptors.

Systems for deriving healthcare provider groups are also disclosed. In one embodiment, the system includes a data storage device configured to store a dataset for a plurality of healthcare providers, where the dataset includes clinical and non-clinical information for each of the plurality of healthcare providers. The system also includes a processor in data communication with the data storage device, where the processor is suitably configured to build, from the plurality of healthcare providers, a plurality of groups of healthcare providers based on analysis of the received clinical information related to medical treatments, and to remove from a particular group of healthcare providers of the plurality of groups one or more healthcare providers determined to be outliers of the particular group. According to an embodiment, the processor of the system is further configured to construct, within the plurality of groups of healthcare providers, a plurality of subgroups of healthcare providers based on analysis of the received non-clinical information related to demographical information. In an embodiment, the processor of the system is also configured to remove from a particular subgroup of healthcare providers of the plurality of subgroups one or more healthcare providers determined to be outliers of the particular subgroup.

In one embodiment, the processor of the system is further configured to identify one or more first-level outlier healthcare providers from the particular group of healthcare providers, where the one or more first-level outlier healthcare providers are of a significant mathematical distance from a centroid of the particular group, and remove the one or more first-level outlier healthcare providers from the particular group. The processor of the system is further configured to identify one or more second-level outlier healthcare providers from the particular subgroup of healthcare providers, where the one or more second-level outlier healthcare providers are of a significant mathematical distance from a centroid of the particular subgroup, and remove the one or more second-level outlier healthcare providers from the particular subgroup. In one embodiment, the second-level outlier healthcare providers removed from the particular subgroup remain in a group of the plurality of groups that contains the particular subgroup.

In an embodiment, the processor of the system is also configured to define a clinical descriptor, based on the stored clinical information, for each of the plurality of healthcare providers, where each clinical descriptor comprises a vector of one or more variables, and to evaluate one or more mathematical distances between multiple clinical descriptors. The processor of the system is further configured to define a non-clinical descriptor, based on the stored non-clinical information, for each of the plurality of healthcare providers, where each non-clinical descriptor comprises a vector of one or more variables, and to evaluate one or more mathematical distances between multiple non-clinical descriptors.

In another embodiment, computer program products having a non-transitory computer readable medium with computer executable instructions are presented. In one embodiment, the computer executable instructions perform the operation of receiving a dataset for a plurality of healthcare providers where the dataset includes clinical and non-clinical information for each of the plurality of healthcare providers. In one embodiment, the computer executable instructions also perform the operations that include building, from the plurality of healthcare providers, a plurality of groups of healthcare providers based on analysis of the received clinical information related to medical treatments, and removing from a particular group of healthcare providers of the plurality of groups one or more healthcare providers determined to be outliers of the particular group. According to an embodiment, the computer executable instructions also perform the operation of constructing, within the plurality of groups of healthcare providers, a plurality of subgroups of healthcare providers based on analysis of the received non-clinical information related to demographical information. In an embodiment, the computer executable instructions further perform the operation of removing from a particular subgroup of healthcare providers of the plurality of subgroups one or more healthcare providers determined to be outliers of the particular subgroup.

In one embodiment, the computer executable instructions also perform the operations of identifying one or more first-level outlier healthcare providers from the particular group of healthcare providers, where the one or more first-level outlier healthcare providers are of a significant mathematical distance from a centroid of the particular group, and removing the one or more first-level outlier healthcare providers from the particular group. The computer executable instructions also perform operations that include identifying one or more second-level outlier healthcare providers from the particular subgroup of healthcare providers, where the one or more second-level outlier healthcare providers are of a significant mathematical distance from a centroid of the particular subgroup, and removing the one or more second-level outlier healthcare providers from the particular subgroup. In one embodiment, the second-level outlier healthcare providers removed from the particular subgroup remain in a group of the plurality of groups that contains the particular subgroup.

In one embodiment, the computer executable instructions also perform the operations of defining a clinical descriptor, based on the received clinical information, for each of the plurality of healthcare providers, where each clinical descriptor comprises a vector of one or more variables, and evaluating one or more mathematical distances between multiple clinical descriptors. The computer executable instructions also perform operations that include defining a non-clinical descriptor, based on the received non-clinical information, for each of the plurality of healthcare providers, where each non-clinical descriptor comprises a vector of one or more variables, and evaluating one or more mathematical distances between multiple non-clinical descriptors.

The term “coupled” is defined as connected, although not necessarily directly, and not necessarily mechanically.

The terms “a” and “an” are defined as one or more unless this disclosure explicitly requires otherwise.

The term “substantially” and its variations are defined as being largely but not necessarily wholly what is specified as understood by one of ordinary skill in the art, and in one non-limiting embodiment “substantially” refers to ranges within 10%, preferably within 5%, more preferably within 1%, and most preferably within 0.5% of what is specified.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a method or device that “comprises,” “has,” “includes” or “contains” one or more steps or elements possesses those one or more steps or elements, but is not limited to possessing only those one or more elements. Likewise, a step of a method or an element of a device that “comprises,” “has,” “includes” or “contains” one or more features possesses those one or more features, but is not limited to possessing only those one or more features. Furthermore, a device or structure that is configured in a certain way is configured in at least that way, but may also be configured in ways that are not listed.

Other features and associated advantages will become apparent with reference to the following detailed description of specific embodiments in connection with the accompanying drawings.

### BRIEF DESCRIPTION OF THE DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 is a schematic block diagram illustrating one embodiment of a system for behavioral clustering.

FIG. 2 is a schematic block diagram illustrating one embodiment of a database system for behavioral clustering.

FIG. 3 is a schematic block diagram illustrating one embodiment of a computer system that may be used in accordance with certain embodiments of the system for behavioral clustering.

FIG. 4 is a schematic logical diagram illustrating one embodiment of abstraction layers of operation in a system for behavioral clustering.

FIG. 5 is a schematic block diagram illustrating one embodiment of a distributed system for behavioral clustering.

FIG. 6 is a schematic block diagram illustrating one embodiment of an apparatus for behavioral clustering.

FIG. 7 is a schematic block diagram illustrating another embodiment of an apparatus for behavioral clustering.

FIG. 8 is a flow chart illustrating one embodiment of a method for behavioral clustering.

FIG. 9 is a flow chart illustrating another embodiment of a method for behavioral clustering.

FIG. 10 is a schematic diagram illustrating results of removing outliers from a group according to one embodiment of a method for behavioral clustering.

FIG. 11 is a schematic diagram illustrating results of hierarchical clustering according to one embodiment of a method for behavioral clustering.

FIG. 12 is a schematic diagram illustrating results of removing outliers from a subgroup according to one embodiment of a method for behavioral clustering.

### DETAILED DESCRIPTION

Various features and advantageous details are explained more fully with reference to the non-limiting embodiments that are illustrated in the accompanying drawings and detailed in the following description. Descriptions of well-known starting materials, processing techniques, components, and equipment are omitted so as not to unnecessarily obscure the disclosure in detail. It should be understood, however, that the detailed description and the specific examples, while indicating embodiments of the disclosure, are given by way of illustration only, and not by way of limitation. Various substitutions, modifications, additions, and/or rearrangements within the spirit and/or scope of the underlying inventive concept will become apparent to those having ordinary skill in the art from this disclosure.

In the following description, numerous specific details are provided, such as examples of programming, software modules, user selections, network transactions, database queries, database structures, hardware modules, hardware circuits, hardware chips, etc., to provide a thorough understanding of disclosed embodiments. One of ordinary skill in the art will recognize, however, that embodiments of the disclosure may be practiced without one or more of the specific details, or with other methods, components, materials, and so forth. In other instances, well-known structures, materials, or operations are not shown or described in detail to avoid obscuring aspects of the disclosure.

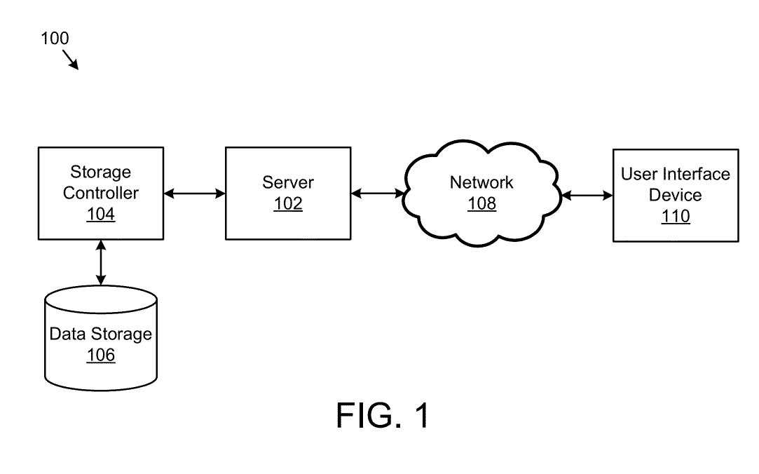

FIG. 1 illustrates one embodiment of a system 100 for behavioral clustering. The system 100 may include a server 102, a data storage device 106, a network 108, and a user interface device 110. In a further embodiment, the system 100 may include a storage controller 104, or storage server configured to manage data communications between the data storage device 106, and the server 102 or other components in communication with the network 108. In an alternative embodiment, the storage controller 104 may be coupled to the network 108.

In one embodiment, the system 100 may receive healthcare data about healthcare providers, where the data may include clinical information about the healthcare providers, such as medical treatment. The medical treatment may be, e.g., prescriptions, instructions, physical treatments or the like that the healthcare providers provide to patients. The data may also include non-clinical information, such as the demographical information about the healthcare providers. The demographical information may be, e.g., location and/or size of the healthcare providers, age/race group of the healthcare providers' patients, or the like. According to another embodiment, other healthcare data that the system 100 may receive may include the type of treatments or procedures being performed, and in what distribution they are being performed. This healthcare data may be associated with medical doctors, nurses, dentists, or other healthcare professionals. As another example, the healthcare data received may include the types and volumes of drugs being dispensed by pharmacists. The healthcare data corresponding to the types of procedures being performed may include extraction, surgery, orthodontia, etc. The system 100 may further cluster the healthcare providers into a plurality of groups based on the clinical information or analysis of the clinical information. Outlier healthcare providers may be removed when clustering. The system 100 may further cluster each of the plurality of groups into a plurality of subgroups based on demographical information or analysis of the demographical information. In the second-level clustering that creates the plurality of subgroups, outlier healthcare providers may be pruned from a certain subgroup, but remain in a first-level group. The system 100 may send the clustering results to the user interface device 110 through the network 108, and present the results to a user.

The user interface device 110 is referred to broadly and is intended to encompass at least a suitable processor-based device such as a desktop computer, a laptop computer, a Personal Digital Assistant (PDA), a mobile communication device, an organizer device, or the like. In a further embodiment, the user interface device 110 may access the Internet to access a web application or web service hosted by the server 102 and provide a user interface for enabling a user to enter or receive information. For example, a user may enter clinical and/or non-clinical information about healthcare providers. The user may also enter preferences such as which algorithm may be used for clustering, the way the clustering results are presented, or the like.

The network 108 may facilitate communications of data between the server 102 and the user interface device 110. The network 108 may include any type of communications network including, but not limited to, a wireless communication link, a direct PC to PC connection, a local area network (LAN), a wide area network (WAN), a modem to modem connection, the Internet, a combination of the above, or any other communications network now known or later developed within the networking arts which permits two or more computers to communicate with another.

In one embodiment, the server 102 may be configured to receive healthcare provider data, cluster healthcare providers into a plurality of groups based on clinical information, further cluster each of the plurality of groups into a plurality of subgroups based on non-clinical information, and present the clustering results to a user. The server 102 may also be configured to remove outliers from the plurality of groups or the plurality of subgroups or both. Additionally, the server 102 may access data stored in the data storage device 104 via a Storage Area Network (SAN) connection, a LAN, a data bus, a wireless link, or the like.

The data storage device 106 may include a hard disk, including hard disks arranged in a Redundant Array of Independent Disks (RAID) array, a tape storage drive comprising a magnetic tape data storage device, an optical storage device, or the like. In one embodiment, the data storage device 104 may store health related data, such as clinical data, insurance claims data, consumer data, or the like. The data storage device 104 may also store non-clinical data. The data may be arranged in a database and accessible through Structured Query Language (SQL) queries, or other data base query languages or operations.

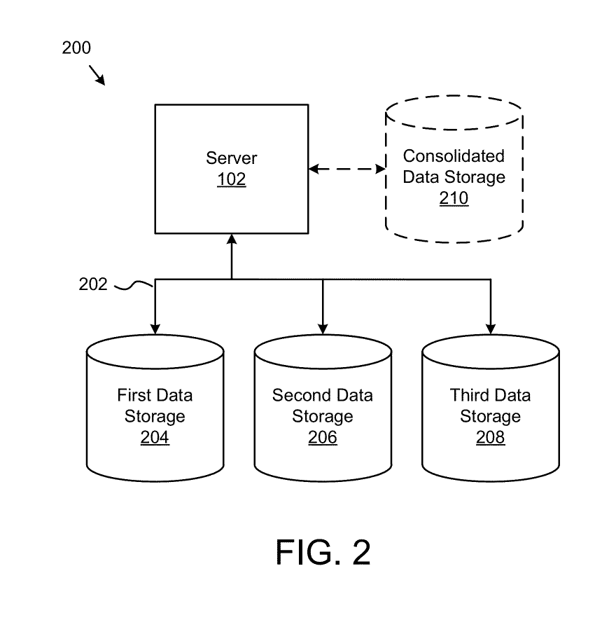

FIG. 2 illustrates one embodiment of a data management system 200 configured to store and manage data for behavioral clustering. In one embodiment, the system 200 may include a server 102. The server 102 may be coupled to a data-bus 202. In one embodiment, the system 200 may also include a first data storage device 204, a second data storage device 206 and/or a third data storage device 208. In other embodiments, the system 200 may include additional data storage devices (not shown). In such an embodiment, each data storage device 204-208 may host a separate database of clinical information about healthcare providers, non-clinical information about healthcare providers, and/or programs to execute clustering algorithms. The healthcare provider information in each database may be keyed to a common field or identifier, such as a healthcare provider's name, healthcare provider number, or the like. The storage devices 204-208 may be arranged in a RAID configuration for storing redundant copies of the database or databases through either synchronous or asynchronous redundancy updates.

In one embodiment, the server 102 may submit a query to selected data storage devices 204-208 to collect a consolidated set of data elements associated with a healthcare provider or a group of healthcare providers. The server 102 may store the consolidated data set in a consolidated data storage device 210. In such an embodiment, the server 102 may refer back to the consolidated data storage device 210 to obtain a set of data elements associated with a specified healthcare provider. Alternatively, the server 102 may query each of the data storage devices 204-208 independently or in a distributed query to obtain the set of data elements associated with a specified healthcare provider. In another alternative embodiment, multiple databases may be stored on a single consolidated data storage device 210.

In various embodiments, the server 102 may communicate with the data storage devices 204-210 over the data bus 202. The data bus 202 may comprise a SAN, a LAN, a wireless connection, or the like. The communication infrastructure may include Ethernet, Fibre-Channel Arbitrated Loop (FC-AL), Small Computer System Interface (SCSI), and/or other similar data communication schemes associated with data storage and communication. For example, the server 102 may communicate indirectly with the data storage devices 204-210; the server first communicating with a storage server or storage controller 104.

In one example of the system 200, the first data storage device 204 may store healthcare data associated with healthcare providers. The healthcare data may include the type of treatments or procedures being performed, and in what distribution they are being performed. The healthcare data may be associated with medical doctors, nurses, dentists, or other healthcare professional. As another example, the healthcare data may include the types and volumes of drugs being dispensed by pharmacists. The healthcare data corresponding to the types of procedures being performed may include extraction, surgery, orthodontia, etc.

In one embodiment, the second data storage device 206 may include clinical information about the healthcare providers, such as medical treatment. The medical treatment may be, e.g., prescriptions, instructions, physical treatments or the like that the healthcare providers provide to patients. The third data storage device 208 may, in another embodiment, include non-clinical information, such as the demographical information about the healthcare providers. The demographical information may be, e.g., location and/or size of the healthcare providers, age/race group of the healthcare providers' patients, or the like. According to one embodiment, the data stored in the data storage device 204-208 may also be stored in one data storage device instead of separate data storage devices 204-208.

The server 102 may host a software application configured for behavioral clustering. The software application may further include modules for interfacing with the data storage devices 204-210, interfacing a network 108, interfacing with a user, and the like. In one embodiment, the server 102 may host an engine, application plug-in, or application programming interface (API). In another embodiment, the server 102 may host a web service or web accessible software application.

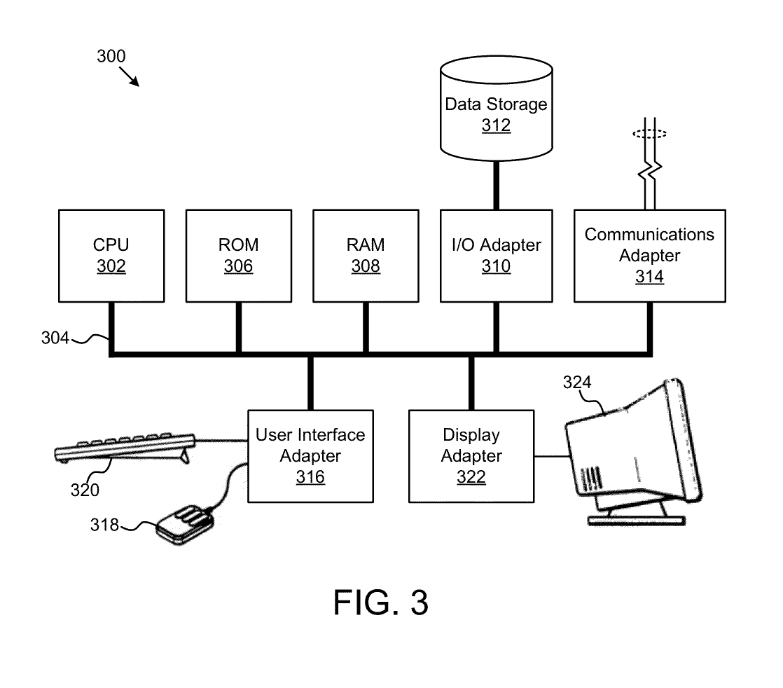

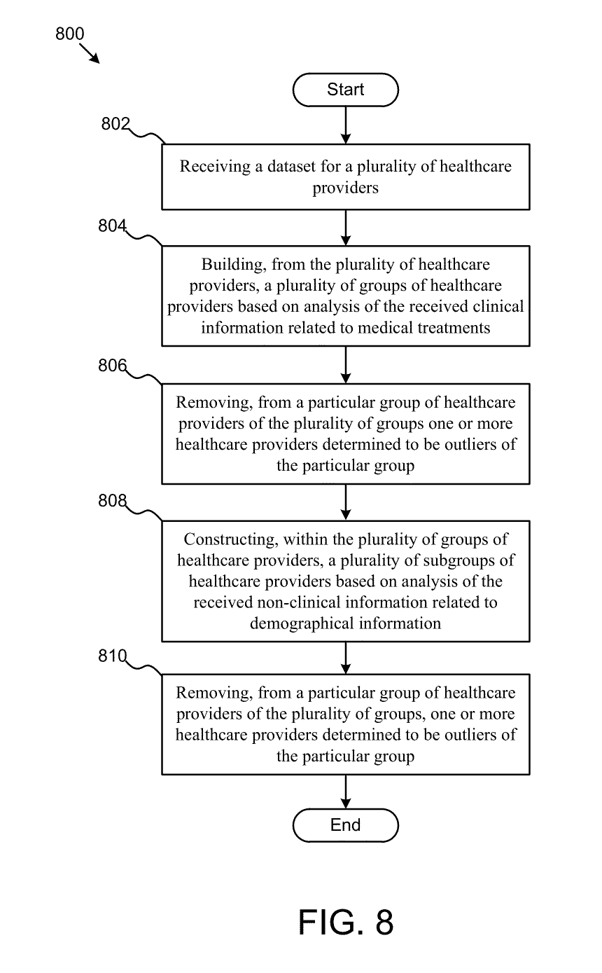

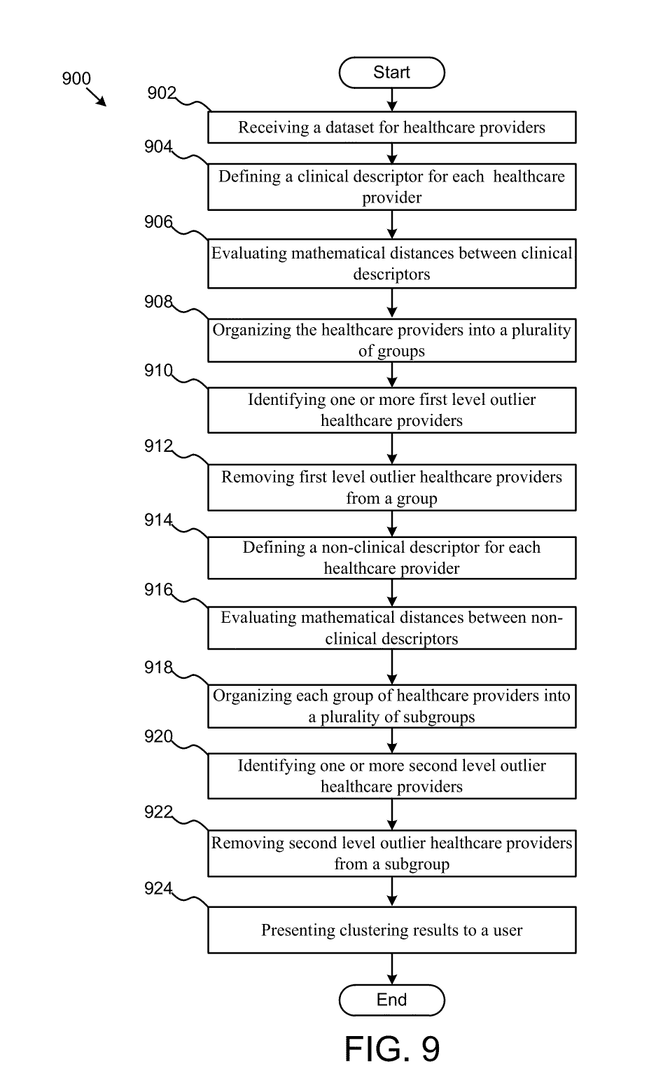

FIG. 3 illustrates a computer system 300 according to certain embodiments of the server 102 and/or the user interface device 110. The central processing unit (CPU) 302 is coupled to the system bus 304. The CPU 302 may be a general purpose CPU or microprocessor. The present embodiments are not restricted by the architecture of the CPU 302, so long as the CPU 302 supports the modules and operations as described herein. The CPU 302 may execute various logical instructions according to disclosed embodiments. For example, the CPU 302 may execute machine-level instructions according to the exemplary operations described below with reference to FIGS. 8-9.

The computer system 300 may include Random Access Memory (RAM) 308, which may be SRAM, DRAM, SDRAM, or the like. The computer system 300 may utilize RAM 308 to store the various data structures used by a software application configured for behavioral clustering. The computer system 300 may also include Read Only Memory (ROM) 306 which may be PROM, EPROM, EEPROM, optical storage, or the like. The ROM may store configuration information for booting the computer system 300. The RAM 308 and the ROM 306 hold user and system 100 data.

The computer system 300 may also include an input/output (I/O) adapter 310, a communications adapter 314, a user interface adapter 316, and a display adapter 322. The I/O adapter 310 and/or user the interface adapter 316 may, in certain embodiments, enable a user to interact with the computer system 300 in order to input information such as clinical and/or non-clinical information about healthcare providers. In a further embodiment, the display adapter 322 may display a graphical user interface associated with a software or web-based application for behavioral clustering.

The I/O adapter 310 may connect to one or more data storage devices 312, such as one or more of a hard drive, a Compact Disk (CD) drive, a floppy disk drive, a tape drive, to the computer system 300. The communications adapter 314 may be adapted to couple the computer system 300 to the network 108, which may be one or more of a wireless link, a LAN and/or WAN, and/or the Internet. The user interface adapter 316 couples user input devices, such as a keyboard 320 and a pointing device 318, to the computer system 300. The display adapter 322 may be driven by the CPU 302 to control the display on the display device 324.

Disclosed embodiments are not limited to the architecture of system 300. Rather, the computer system 300 is provided as an example of one type of computing device that may be adapted to perform functions of a server 102 and/or the user interface device 110. For example, any suitable processor-based device may be utilized including, without limitation, personal data assistants (PDAs), computer game consoles, and multi-processor servers. Moreover, the present embodiments may be implemented on application specific integrated circuits (ASIC) or very large scale integrated (VLSI) circuits. In fact, persons of ordinary skill in the art may utilize any number of suitable structures capable of executing logical operations according to the disclosed embodiments.

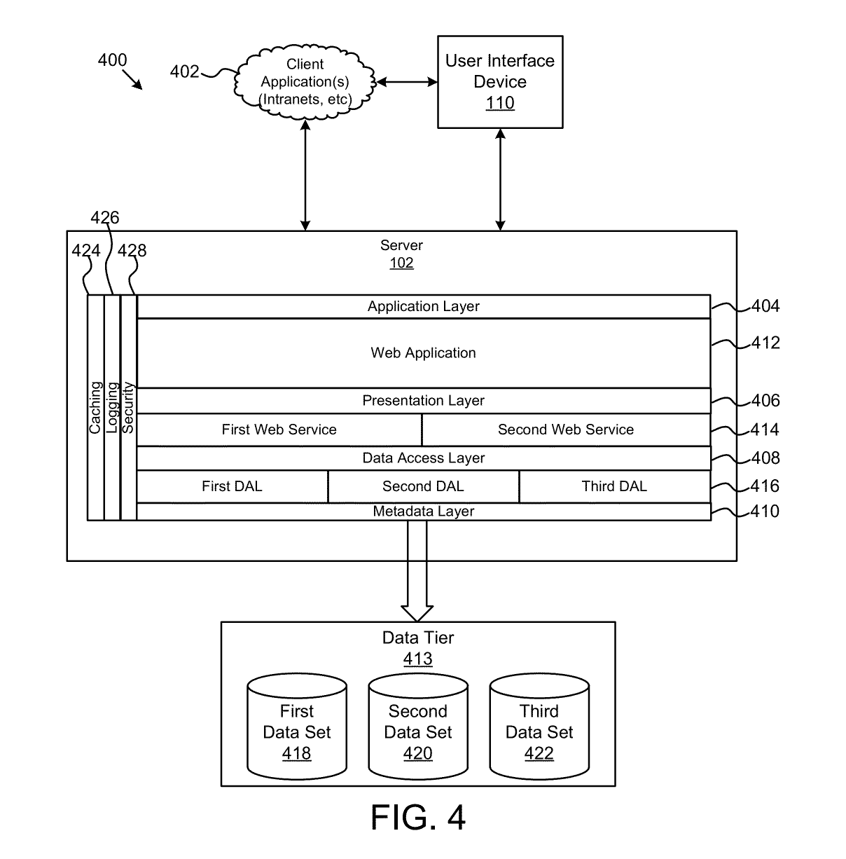

FIG. 4 illustrates one embodiment of a network-based system 400 for behavioral clustering. In one embodiment, the network-based system 400 includes a server 102. Additionally, the network-based system 400 may include a user interface device 110. In still a further embodiment, the network-based system 400 may include one or more network-based client applications 402 configured to be operated over a network 108 including a wireless network, an intranet, the Internet, or the like. In still another embodiment, the network-based system 400 may include one or more data storage devices 104.

The network-based system 400 may include components or devices configured to operate in various network layers. For example, the server 102 may include modules configured to work within an application layer 404, a presentation layer 406, a data access layer 408 and a metadata layer 410. In a further embodiment, the server 102 may access one or more data sets 418-422 that comprise a data layer or data tier 413. For example, a first data set 418, a second data set 420 and a third data set 422 may comprise a data tier 413 that is stored on one or more data storage devices 204-208.

One or more web applications 412 may operate in the application layer 404. For example, a user may interact with the web application 412 though one or more I/O interfaces 318, 320 configured to interface with the web application 412 through an I/O adapter 310 that operates on the application layer. In one embodiment, a web application 412 may be provided for behavioral clustering that includes software modules configured to perform the steps of receiving a dataset with clinical and non-clinical information for healthcare providers, clustering the healthcare providers into a plurality of groups based on the clinical information, clustering each of the plurality of groups into a plurality of subgroups based on non-clinical information, removing outliers from groups or subgroups or both, and presenting the clustering results to a user.

In a further embodiment, the server 102 may include components, devices, hardware modules, or software modules configured to operate in the presentation layer 406 to support one or more web services 414. For example, a web application 412 may access or provide access to a web service 414 to perform one or more web-based functions for the web application 412. In one embodiment, web application 412 may operate on a first server 102 and access one or more web services 414 hosted on a second server (not shown) during operation.

For example, a web application 412 for behavioral clustering using healthcare data, or other data, may access a first web service 414 to build, from the plurality of healthcare providers, a plurality of groups of healthcare providers based on analysis of the received clinical information related to medical treatments, and to remove from a particular group of healthcare providers of the plurality of groups one or more healthcare providers determined to be outliers of the particular group. A second web service 414 to construct, within the plurality of groups of healthcare providers, a plurality of subgroups of healthcare providers based on analysis of the received non-clinical information related to demographical information, and to remove from a particular subgroup of healthcare providers of the plurality of subgroups one or more healthcare providers determined to be outliers of the particular subgroup. In another embodiment, separate web services may be used to build the groups, remove outliers from the groups, construct the subgroups, and remove outliers from the subgroups. In yet another embodiment, a single web service may be used to build the groups, remove outliers from the groups, construct the subgroups, and remove outliers from the subgroups. One of ordinary skill in the art will recognize various web-based architectures employing web services 414 for modular operation of a web application 412.

In one embodiment, a web application 412 or a web service 414 may access one or more of the data sets 418-422 through the data access layer 408. In certain embodiments, the data access layer 408 may be divided into one or more independent data access layers 416 for accessing individual data sets 418-422 in the data tier 413. These individual data access layers 416 may be referred to as data sockets or adapters. The data access layers 416 may utilize metadata from the metadata layer 410 to provide the web application 412 or the web service 414 with specific access to the data set 412. For example, the data access layer 416 may include operations for performing a query of the data sets 418-422 to retrieve specific information for the web application 412 or the web service 414.

For example, the data access layer 416 may include operations for performing a query of the data sets 418-422 to retrieve specific information for the web application 412 or the web service 414. In a more specific example, the data access layer 416 may include a query for records with clinical and non-clinical information about healthcare providers.

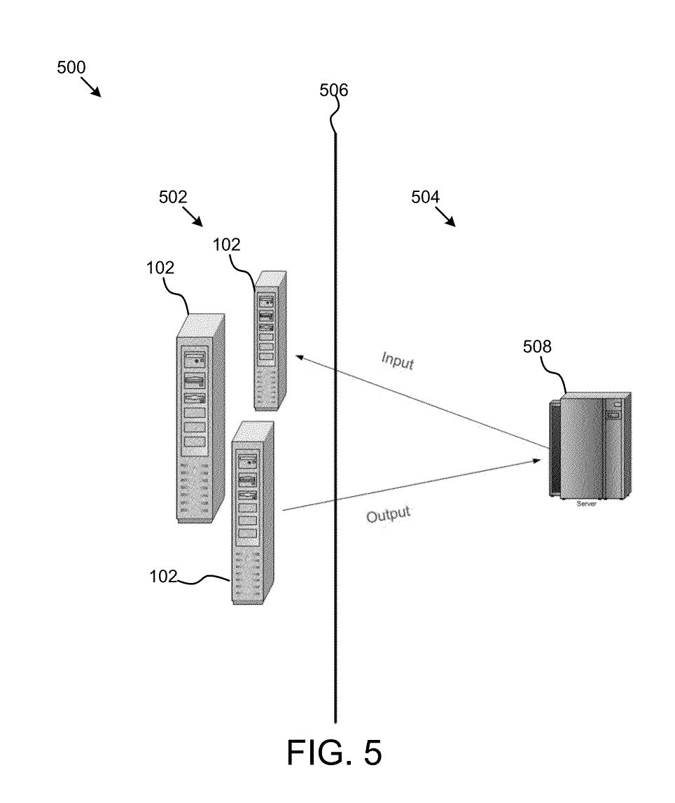

FIG. 5 illustrates a further embodiment of a system 500 for behavioral clustering. In one embodiment, the system 500 may include a service provider site 502 and a client site 504. The service provider site 502 and the client site 504 may be separated by a geographic separation 506.

In one embodiment, the system 500 may include one or more servers 102 configured to host a software application 412 for behavioral clustering, or one or more web services 414 for performing certain functions associated with behavioral clustering. The system may further comprise a user interface server 508 configured to host an application or web page configured to allow a user to interact with the web application 412 or web services 414 for behavioral clustering. In such an embodiment, a service provider may provide hardware 102 and services 414 or applications 412 for use by a client without directly interacting with the client's customers.

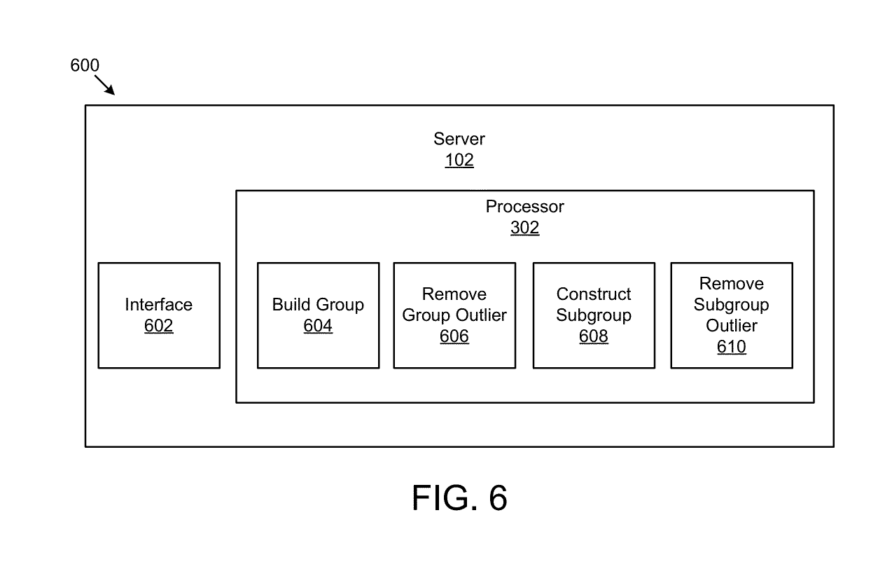

FIG. 6 illustrates one embodiment of an apparatus 600 for behavioral clustering. In one embodiment, the apparatus 600 is a server 102 configured to load and operate software modules 602-608 configured for behavioral clustering. Alternatively, the apparatus 600 may include hardware modules 602-608 configured with analog or digital logic, firmware executing FPGAs, or the like configured to receive a dataset with clinical and non-clinical information for healthcare providers, cluster the healthcare providers into a plurality of groups based on the clinical information, cluster each of the plurality of groups into a plurality of subgroups based on non-clinical information, remove outliers from groups, subgroups or both groups and subgroups, and present the clustering results to a user. In such embodiments, the apparatus 600 may include a processor 302 and an interface 602, such as an I/O adapter 310, a communications adapter 314, a user interface adapter 316, or the like.

In one embodiment, the processor 302 may include one or more software defined modules configured to receive a dataset with clinical and non-clinical information for healthcare providers, cluster the healthcare providers into a plurality of groups based on the clinical information, cluster each of the plurality of groups into a plurality of subgroups based on non-clinical information, remove outliers from groups, subgroups or both groups and subgroups, and present the clustering results to a user. In one embodiment, these modules may include an interface module to receive a dataset for a plurality of healthcare providers, a build group module 604 to cluster the healthcare providers into a plurality of groups based on the clinical information, a remove group outlier module 606 to remove outliers from one or more groups, a construct subgroup module 608 to cluster each of the plurality of groups into a plurality of subgroups based on non-clinical information, and a remove subgroup outlier 610 module to remove outliers from one or more subgroups.

The dataset received by interface 602 according to an embodiment of the present disclosure may be healthcare data about healthcare providers. The healthcare data may include clinical information and non-clinical information about healthcare providers. For example, healthcare data may, in certain embodiments, include clinical information about the healthcare providers, such as medical treatment. The medical treatment may be, e.g., prescriptions, instructions, physical treatments or the like that the healthcare providers provide to patients.

In a further example, the healthcare data may include non-clinical information, such as the demographical information about the healthcare providers. The demographical information may be, e.g., location and/or size of the healthcare providers, age/race group of the healthcare providers' patients, or the like.

According to another embodiment, other healthcare data that the system 100 may receive may include the type of treatments or procedures being performed, and in what distribution they are being performed. This healthcare data may be associated with medical doctors, nurses, dentists, or other healthcare professional. As another example, the healthcare data received may include the types and volumes of drugs being dispensed by pharmacists. The healthcare data corresponding to the types of procedures being performed may include extraction, surgery, orthodontia, etc.

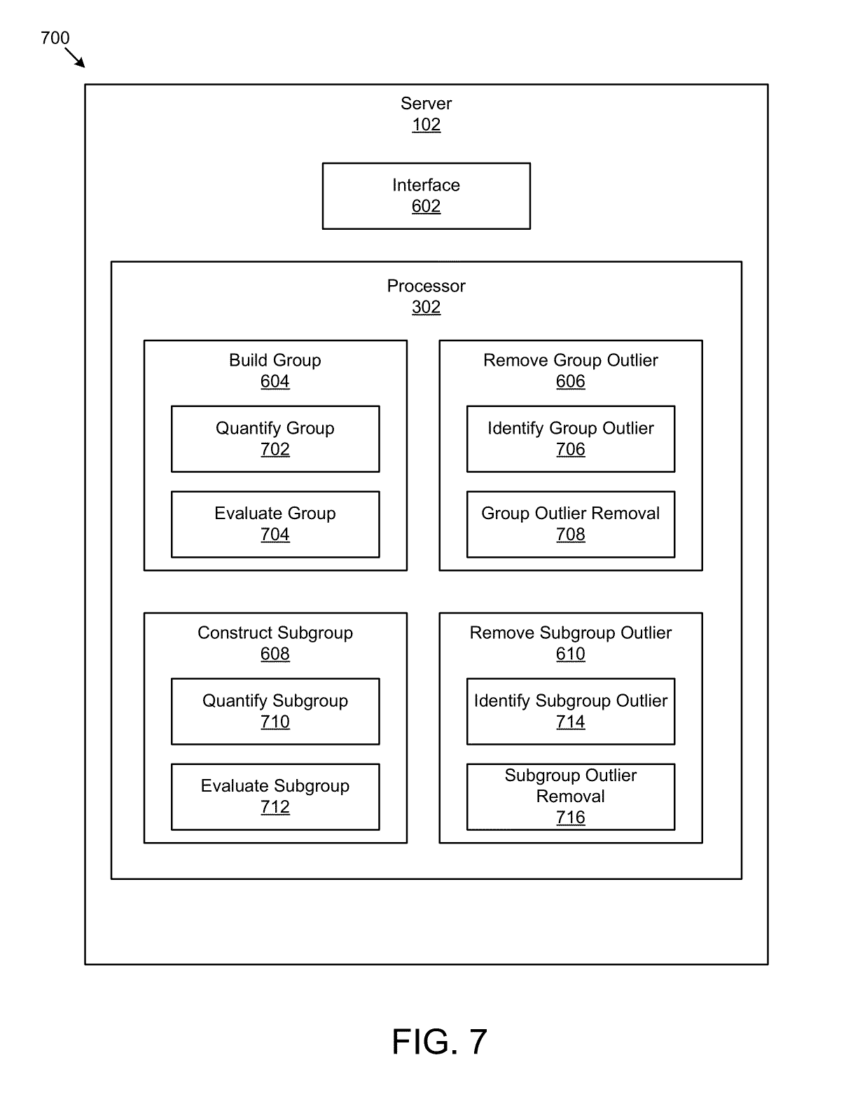

Although the various functions of the server 102 and the processor 302 are described in the context of modules, the methods, processes, and software described herein are not limited to a modular structure. Rather, some or all of the functions described in relation to the modules of FIGS. 6-7 may be implemented in various formats including, but not limited to, a single set of integrated instructions, commands, code, queries, etc. In one embodiment, the functions may be implemented in database query instructions, including SQL, PLSQL, or the like. Alternatively, the functions may be implemented in software coded in C, C++, C#, php, Java, or the like. In still another embodiment, the functions may be implemented in web based instructions, including HTML, XML, etc.

Generally, the interface module 602 may receive user inputs and display user outputs. For example, the interface module 602 may receive a dataset with clinical and non-clinical information for healthcare providers. In a further embodiment, the interface module 602 may display healthcare provider behavioral clustering results for behavioral inferences. Such results may include statistics, tables, charts, graphs, recommendations, and the like.

Structurally, the interface module 602 may include one or more of an I/O adapter 310, a communications adapter 314, a user interface adapter 316, and/or a display adapter 322. The interface module 602 may further include I/O ports, pins, pads, wires, busses, and the like for facilitating communications between the processor 302 and the various adapters and interface components 310-324. The interface module may also include software defined components for interfacing with other software modules on the processor 302.

In one embodiment, the processor 302 may load and execute software modules configured to cluster the healthcare providers into a plurality of groups based on the clinical information, cluster each of the plurality of groups into a plurality of subgroups based on non-clinical information, remove outliers from groups, subgroups or both groups and subgroups, and present the clustering results to a user for analysis of behavioral inferences. These software modules may include a build group module 604 to cluster the healthcare providers into a plurality of groups based on the clinical information, a remove group outlier module 606 to remove outliers from one or more groups, a construct subgroup module 608 to cluster each of the plurality of groups into a plurality of subgroups based on non-clinical information, and a remove subgroup outlier module 610 to remove outliers from one or more subgroups.

In a specific embodiment, the processor 302 may load and execute computer software configured to cluster healthcare providers into a plurality of groups based on the clinical information about the healthcare providers. For example, the build group module 604 may build, from the plurality of healthcare providers, a plurality of groups of healthcare providers based on analysis of the received clinical information. The clinical information may include, for example, the type of procedures or medical treatments being performed by medical doctors or dentists or it may include the types and volumes of drugs being dispensed by pharmacists. The medical treatment may be, e.g., prescriptions, instructions, physical treatments or the like that the healthcare providers provide to patients. An analysis of the clinical information may yield, in certain embodiments, a distribution of the procedures or medical treatments performed. Based on this clinical information, the build group module 604 may, in one embodiment, cluster all dentists who perform the same procedure, such as a surgery, together in one group while those who perform a different procedure, such as an extraction, may be clustered in a different group.

The remove group outlier module 606 may, in one embodiment, be configured to remove from a particular group of healthcare providers of the plurality of groups one or more healthcare providers determined to be outliers of the particular group. According to another embodiment, multiple outliers of different respective groups of healthcare providers may be removed in a parallel or sequential manner. Mathematical analysis may be performed on one or more groups of healthcare providers to identify the one or more healthcare providers determined to be outliers to their respective group of healthcare providers. For example, clinical descriptors may be used to quantify a healthcare provider's behavior. One would expect the behavior of healthcare providers with similar training and experience to be similar, and therefore have similar clinical descriptors. By quantifying the behavior of healthcare providers, mathematical analysis may be performed on a group of clustered healthcare providers, and those healthcare providers who exhibit distinct behaviors dissimilar from the behaviors of others within the group may be determined to be outliers and removed from the group.

According to yet another embodiment, the construct subgroup module 608 be configured to construct, within the plurality of groups of healthcare providers, a plurality of subgroups of healthcare providers based on analysis of the received non-clinical information. In one embodiment, the plurality of groups may be further clustered into subgroups of healthcare providers after the outliers from the groups of healthcare providers have been removed, while in another embodiment the subgroups may be constructed prior to the removal of outliers from the groups of healthcare providers. The non-clinical information may include, for example, demographical information about the healthcare providers. The demographical information may be, e.g., location and/or size of the healthcare providers, age/race group of the healthcare providers' patients, or the like. As an example of one embodiment, based on analysis of the non-clinical information, the construct subgroup module 608 may cluster a group of dentists who perform a surgical procedure into subgroups of dentists based on the population density of the dentists or of their patients.

The remove subgroup outlier module 610 may, according to an embodiment, remove from a particular subgroup of healthcare providers of the plurality of subgroups one or more healthcare providers determined to be outliers of the particular subgroup. According to another embodiment, multiple outliers of different respective subgroups of healthcare providers may be removed in a parallel or sequential manner. Mathematical analysis may be performed on one or more subgroups of healthcare providers to identify the one or more healthcare providers determined to be outliers to their respective subgroup of healthcare providers. For example, non-clinical descriptors may be used to further quantify a healthcare provider's behavior based on non-clinical information. By quantifying the behavior of healthcare providers based on different information than what was used to quantify the healthcare providers previously, more mathematical analysis may be performed on a subgroup of clustered healthcare providers, and those healthcare providers who exhibit distinct behaviors dissimilar from the behaviors of others within the subgroup may be determined to be outliers and removed from the subgroup. This process further ensures that true cohorts of healthcare providers can be identified, and that healthcare providers who don't fit in to a specific group or subgroup can also be identified and not penalized for being genuinely unique.

FIG. 7 illustrates a further embodiment of an apparatus 700 for behavioral clustering. The apparatus 700 may include a server 102 and an interface 602 as described in FIG. 6. The interface 602 may be configured to receive a dataset for a plurality of healthcare providers, where the dataset includes clinical and non-clinical information about the plurality of healthcare providers. In a further embodiment, the processor 302 and its modules 604-610 may include additional software-defined modules. For example, the build group module 604 may include a quantify group module 702 and an evaluate group module 704, and the remove group outlier module 606 may include an identify group outlier module 706 and a group outlier removal module 708. Furthermore, the construct subgroup module 608 may include a quantify subgroup module 710 and an evaluate subgroup module 712, and the remove subgroup outlier module 610 may include an identify subgroup outlier module 714 and a subgroup outlier removal module 716.

In one embodiment, the quantify group module 702 may define a clinical descriptor, based on the received clinical information, for each of the plurality of healthcare providers, where each clinical descriptor comprises a vector of one or more variables. A clinical descriptor may be created to quantify a healthcare provider's behavior based on clinical information about the health provider. According to one embodiment, each healthcare provider may have a plurality of clinical descriptors. According to another embodiment, each healthcare provider may have a unique clinical descriptor, and multiple clinical descriptors may be created to quantify the behavior of a plurality of health providers. The vector of one or more variables may become a healthcare provider vector used to perform mathematical analysis on the healthcare provider. Furthermore, the vector of one or more variables may be organized to control the dimensionality and may be standardized to ensure proper comparisons among healthcare providers are established. According to another embodiment, to arrive at the proper number and structure of variables for each clinical descriptor, the actions of the quantify group module 702 may be performed with a subject matter expert (SME) and/or a modeler. That is, steps performed by the quantify group module 702 may include actions taken by an expert to supply knowledge and/or a mathematical modeler to provide mathematical models of certain metrics.

According to an embodiment, the evaluate group module 704 may evaluate one or more mathematical distances between multiple clinical descriptors. For example, the evaluate group module 704 may execute distance-based mathematical algorithms for a plurality of healthcare providers using the clinical descriptors corresponding to the plurality of healthcare providers. According to one embodiment, healthcare providers with the same amount of training and experience may have similar clinical descriptors.

Many different algorithms may be used to evaluate mathematical distances between clinical descriptors. As one example, the clinical descriptors for a healthcare provider i may be represented by a vector xᵢ. If a K-means algorithm is used, then a centroid vector μ may be set to the mean value of a temporary set of clinical descriptors for a plurality of healthcare providers. For example, K healthcare providers may be randomly selected to calculate a mean vector as centroid vector μ. A mathematical distance between healthcare provider i and the centroid of the temporary set of healthcare providers may be evaluated by the Mahalanobis distance between xᵢ and μ. If the covariance matrix of xᵢ over all healthcare providers is represented by a matrix S, then the Mahalanobis distance between the vector of clinical descriptors xᵢ of healthcare provider i may be calculated as D_{M}(xᵢ)=\sqrt{(xᵢ−μ)^{T}S⁻¹(xᵢ−μ)}. In one embodiment, the inverse matrix of matrix S may be calculated by exploiting a Cholesky decomposition. The use of a Cholesky decomposition may, according to one embodiment, reduce the number of operations performed. Based on the mathematical distances between clinical descriptors, the build group module 604 may cluster the healthcare providers into a plurality of groups of healthcare providers. In one embodiment, after K-means algorithms converge, (e.g., after a stop criteria has been met), final centroids may be calculated for each cluster, and each healthcare provider may be assigned to a centroid that is closest to the healthcare provider's corresponding vector of clinical descriptors.

In using a K-means algorithm, many specifications may vary by environment. For example, the number of starting centroids (K), the rules for collapsing low-member centroids, the minimum healthcare provider requirements to qualify for a cluster, and the stopping criteria may all vary by environment.

According to one embodiment, the identify group outlier module 706 may identify one or more first-level outlier healthcare providers from a particular group of healthcare providers, wherein the one or more first-level outlier healthcare providers are of a significant mathematical distance from a centroid of the particular group of healthcare providers. For example, if the distance between xᵢ (the vector of clinical descriptors for healthcare provider i) and the centroid μⱼ (centroid of group j to which healthcare provider i belongs) is larger than a threshold, then healthcare provider i may be identified as a first-level outlier healthcare provider. In one embodiment, a threshold for determining an outlier of a cluster may be selected based on the relative tightness of the cluster and the Mahalanobis distance of xᵢ from the centroid of the cluster. For example, if the cluster is densely populated around the centroid, the threshold distance required to identify outliers may be less than a cluster which is not as dense.

With healthcare providers grouped into clusters, centroids evaluated for the clusters, and thresholds established for the clusters, the group outlier removal module 708 may remove the one or more first-level outlier healthcare providers from the particular group. In one embodiment, the one or more first-level outlier healthcare providers removed from a particular group may be the healthcare providers with vectors of clinical descriptors that are a significant mathematical distance from the centroid of the clustered group (e.g., the healthcare providers with vectors of clinical descriptors that exceed the threshold established for the group).

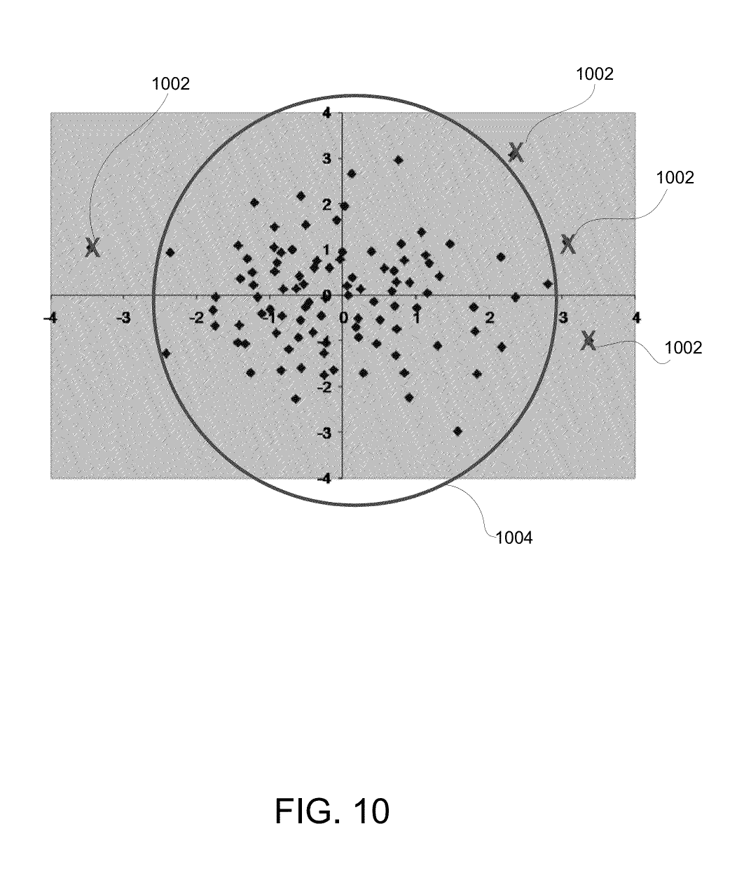

FIG. 10 provides an illustration of the result of removing outliers from a group according to one embodiment of a method for behavioral clustering. The threshold distance to a centroid may be denoted by a circle 1004. According to an embodiment, this threshold may be specific to this particular cluster of healthcare providers, and another cluster (e.g., group) of healthcare providers may have a threshold with a different distance to a centroid of the group. Furthermore, those healthcare providers 1002 that lie outside the threshold circle 1004 may be the healthcare providers 1002 that are determined to be a significant mathematical distance from a centroid. Through the identification of first-level outlier healthcare providers and their removal, the remove group outlier module 606 may ensure that healthcare providers that exhibit similar clinical behavior are grouped together so that more accurate inferences may be made regarding a particular healthcare provider's behavior.

According to an embodiment, the quantify subgroup module 710 may define a non-clinical descriptor, based on the received non-clinical information, for each of the plurality of healthcare providers, where each non-clinical descriptor comprises a vector of one or more variables. A non-clinical descriptor may be created to quantify a healthcare provider's behavior based on non-clinical information about the healthcare provider to allow for segregation based on non-clinical metrics among healthcare providers who display similar clinical behaviors. According to one embodiment, each healthcare provider may have a plurality of non-clinical descriptors. According to another embodiment, each healthcare provider may have a unique non-clinical descriptor, and multiple non-clinical descriptors may be created to quantify the behavior of a plurality of health providers. The vector of one or more variables may become a healthcare provider vector used to perform further mathematical analysis on the healthcare provider. According to another embodiment, to arrive at the proper number and structure of variables for each non-clinical descriptor, the actions of the quantify group module 710 may be performed jointly with an SME and modelers.

According to one embodiment, non-clinical descriptors may depend on the type of healthcare data being analyzed and other factors. For example, non-clinical descriptors may include geographic considerations, such as population density of either the healthcare provider or the healthcare provider's patients. Furthermore, non-clinical descriptors may include a size indicator of a given healthcare provider that measures the volume of treatment or the diversity, and may include diversity measures, such as evenness of procedure distribution or Shannon index. Presence of special events, such as emergency or laboratory procedures may also be included by non-clinical descriptors. According to another embodiment, defining a non-clinical descriptor may include selecting a number of non-clinical parameters, determining an order for the non-clinical parameters, assigning a value to each non-clinical parameter, and grouping the values into a vector.

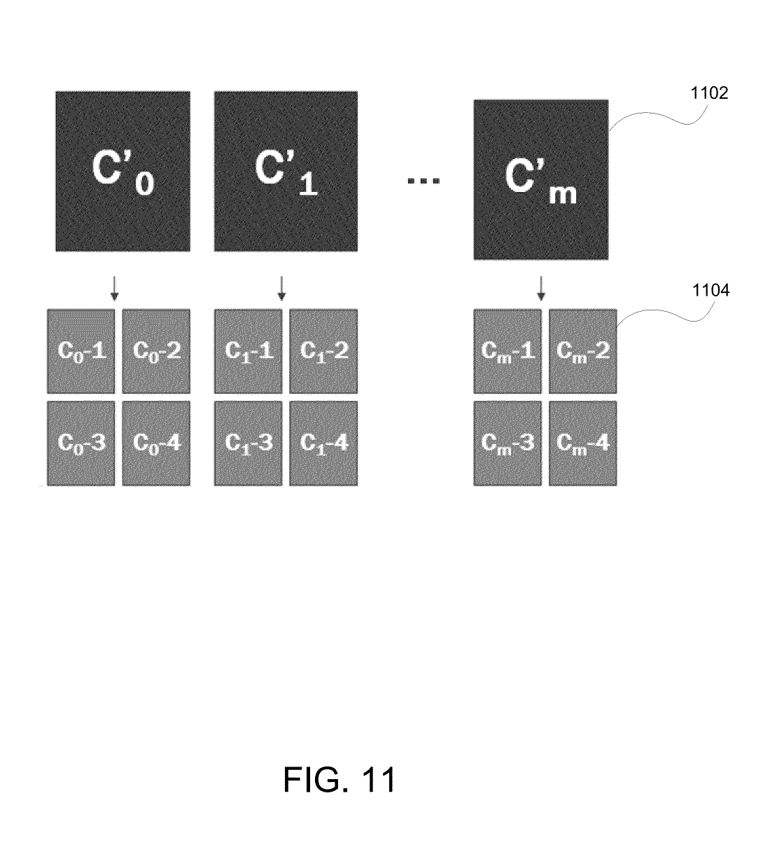

According to an embodiment, the evaluate subgroup module 712 may evaluate one or more mathematical distances between multiple non-clinical descriptors. Many different algorithms may be used to evaluate mathematical distances between non-clinical descriptors. In one embodiment, the algorithms used the evaluate mathematical distances between clinical descriptors, such as the K-means algorithm described in detail previously, may also be used to evaluate mathematical distances between multiple non-clinical descriptors. Evaluation of mathematical distances between non-clinical descriptors may be performed within each group healthcare providers clustered according to their clinical behavior to further cluster the healthcare providers into subgroups based on their non-clinical behavioral tendencies. Based on the mathematical distances between non-clinical descriptors, the construct subgroup module 608 may further cluster the healthcare providers into a plurality of subgroups of healthcare providers. In one embodiment, after a stop criteria has been met, final centroids may be calculated for each subgroup within a group of healthcare providers, and each healthcare provider within the group may be assigned to a subgroup centroid that is closest to the healthcare provider's corresponding vector of non-clinical descriptors. FIG. 11 provides an illustration of the result of hierarchical clustering according to one embodiment of a method for behavioral clustering. After removing the first-level outlier healthcare providers, each group of healthcare providers 1102 (denoted as C′₀, C′₁, . . . C′ₘ) may be further clustered into a plurality of subgroups 1104. For example, group C′₀ may be further clustered in to subgroups C₀-1, C₀-2, C₀-3, and C₀-4.

According to another embodiment, the identify subgroup module 714 may identify one or more second-level outlier healthcare providers from a particular subgroup of healthcare providers, wherein the one or more second-level outlier healthcare providers are of a significant mathematical distance from a centroid of the particular subgroup. A significant mathematical distance may correspond to a distance between a healthcare provider's vector of non-clinical descriptors and a centroid of a subgroup that lies outside a threshold specific to the subgroup, where the factors used to determine the threshold for a subgroup may be the same as the factors used to determine a threshold for a group.

The subgroup outlier removal module 716 may then remove the one or more second-level outlier healthcare providers from the particular subgroup. In one embodiment, the one or more second-level outlier healthcare providers removed from a particular subgroup may be the healthcare providers with vectors of non-clinical descriptors that are a significant mathematical distance from the centroid of the clustered subgroup. Through the identification of second-level outlier healthcare providers and their removal, the remove subgroup outlier module 610 may ensure that healthcare providers that exhibit similar non-clinical behavior are grouped together so that more accurate inferences may be made regarding a particular healthcare provider's behavior.

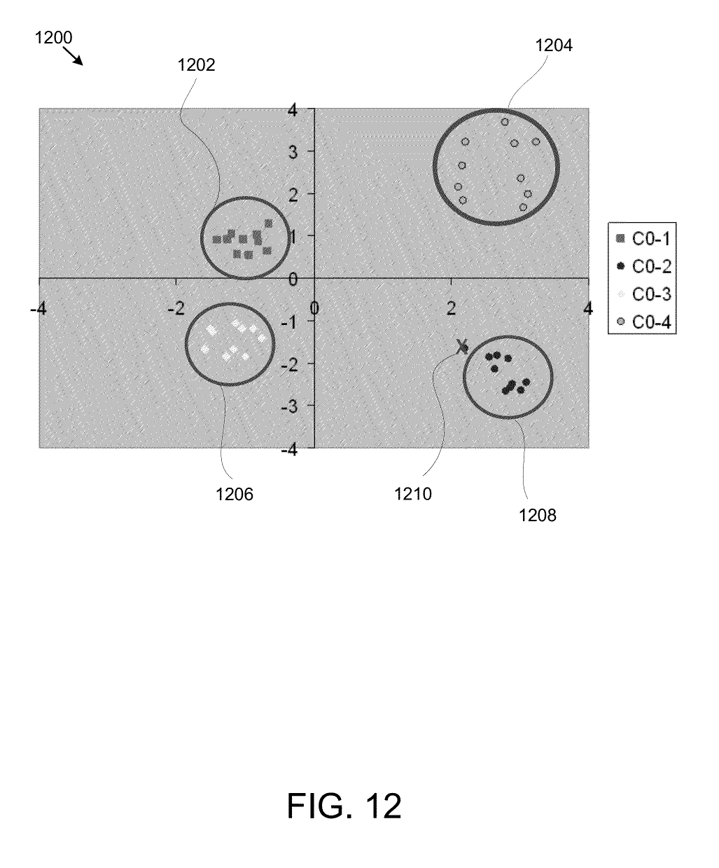

FIG. 12 provides an illustration of the result of removing outliers from a subgroup according to one embodiment of a method for behavioral clustering. In the illustrated embodiment, group 1200 may be grouped into subgroups 1202, 1204, 1206, and 1208. In such an embodiment, healthcare provider 1210 may be identified as a second-level outlier healthcare provider, and may be removed from the subgroup 1208. However, healthcare provider 1210 remains in group 1200, which contains subgroup 1208. Therefore, although a second-level outlier healthcare provider may be removed from a particular subgroup, the same second-level outlier healthcare provider removed from the particular subgroup may, in certain embodiments, remain in a group of the plurality of groups that contains the particular subgroup.

In one embodiment, the interface module 602 may present the clustering results from FIG. 7 to a user. In a further embodiment, the interface module 602 may allow a user to input preferences, such as which clustering algorithm to use to generate healthcare provider groups and/or subgroups, how the clustering results is displayed, or the like.

The schematic flow chart diagrams that follow are generally set forth as logical flow chart diagrams. As such, the depicted order and labeled steps are indicative of one embodiment of the present disclosure. Other steps and methods may be employed that are equivalent in function, logic, or effect to one or more steps, or portions thereof, of the illustrated method. Additionally, the format and symbols employed are provided to explain logical steps and should be understood as not limiting the scope of the disclosure. Although various arrow types and line types may be employed in the flow chart diagrams, they should be understood as not limiting the scope of the corresponding method. Indeed, some arrows or other connectors may be used to indicate only the logical flow of the method. For instance, an arrow may indicate a waiting or monitoring period of unspecified duration between enumerated steps. Additionally, the order in which a particular method occurs may or may not strictly adhere to the order of the corresponding steps shown.

FIG. 8 illustrates one embodiment of a method 800 for behavioral clustering. In one embodiment, the method 800 starts at block 802 with receiving a dataset for a plurality healthcare providers. In one embodiment, the dataset may include clinical and non-clinical information for each of the healthcare providers. At block 804, the method 800 may include building, from the plurality of healthcare providers, a plurality of groups of healthcare providers based on analysis of the received clinical information. In one embodiment, at block 804 the healthcare providers may be clustered into a plurality of groups based on clinical information related to medical treatments. The medical treatments may include instructions, prescriptions, physical treatments, or the like. The medical treatments may also include type and/or distribution of treatments provided to patients, types and/or distribution of procedures, e.g., extraction, surgery or orthodontia, and/or types and volumes of drugs dispensed.

The method 800 may further include, at block 806, removing from a particular group of healthcare providers of the plurality of groups one or more healthcare providers determined to be outliers of the particular group. According to another embodiment, multiple outliers of different respective groups of healthcare providers may be removed in a parallel or sequential manner.

In one embodiment, the method 800 may further include, at block 808, constructing, within the plurality of groups of healthcare providers, a plurality of subgroups of healthcare providers based on analysis of the received non-clinical information. According to an embodiment, the non-clinical information may be related to demographical information of the healthcare providers. The demographical information of the healthcare providers may be location/size of the healthcare providers/patients, population density/distribution of patients treated by the healthcare providers, volume of treatments provided by the healthcare providers, diversity measure such as evenness of procedure distribution or Shannon index, and/or presence of special events, such as emergency or laboratory procedures.

The method 800 may further include, at block 810, removing from a particular subgroup of healthcare providers of the plurality of subgroups one or more healthcare providers determined to be outliers of the particular subgroup. According to another embodiment, multiple outliers of different respective groups of healthcare providers may be removed in a parallel or sequential manner.

During removal at block 810, when a remaining group or subgroup is below a threshold size, the group or subgroup may be removed and the providers within the group or subgroup may be reassigned to nearby groups and/or subgroups. That is, groups or subgroups that are too small may be collapsed, and the providers in the groups are reassigned to one or different groups or subgroups.

After healthcare providers are removed as outliers, the healthcare providers may be provided a closer examination to identify why the healthcare provider is performing differently from other healthcare providers. Examination of these outliers may be useful in identifying a cause for the anomaly. For example, a closer examination of an outlier may reveal that the outlier healthcare provider may be changing behavior in response to a policy change.

In one embodiment, the actions performed at blocks 804 and 808 may be based on a K-means algorithm. The actions performed at blocks 804 and 808 may also be based on an expectation-maximization (EM) algorithm, a hierarchical clustering algorithm, a co-clustering algorithm, or the like.

In one embodiment, the clustering results may be used to make inferences about healthcare providers. For example, it may be assumed that behaviors of all healthcare providers in the same group should be similar. Based on this, inferences may be made, such as dentist X performs a significantly elevated number of tooth extractions per patient, healthcare provider Y has accelerated use of a certain code in a manner that is not typical for this healthcare provider, or pharmacist Z has dispensed a portion of a specific drug in the last ten days that is significantly higher than the typical rate.

FIG. 9 illustrates one embodiment of a method 900 for behavioral clustering. In one embodiment, the method 900 starts at block 902 with receiving a dataset for healthcare providers. The dataset may include clinical and non-clinical information about each healthcare provider. The method 900 may include, at block 904, defining a clinical descriptor for each healthcare provider, where each clinical descriptor may be based on clinical information included in the received dataset. The clinical descriptor defined at block 904 may be a vector of variables. In one embodiment, defining a clinical descriptor may include selecting a number of clinical parameters, determining an order for the clinical parameters, assigning a value to each clinical parameter, and grouping the values into a vector.

In one embodiment, the method 900 may include, at block 906, evaluating mathematical distances between clinical descriptors. For example, the clinical descriptor for a healthcare provider i may be represented by vector xᵢ. If a K-means algorithm is used, then a centroid vector μ may be set to the mean value of a temporary set of clinical descriptors for healthcare providers. For example, K healthcare providers may be randomly selected to calculate a mean vector as centroid vector μ. A mathematical distance between healthcare provider i and the centroid of the temporary set of healthcare providers may be evaluated by the Mahalanobis distance between xᵢ and μ. If the covariance matrix of xᵢ over all healthcare providers is represented by a matrix S, the Mahalanobis distance between the vector of clinical descriptor xᵢ of healthcare provider i may be calculated as D_{M}(xᵢ)=\sqrt{(xᵢ−μ)^{T}S⁻¹(xᵢ−μ)}. In one embodiment, the inverse matrix of matrix S may be calculated by exploiting Cholesky decomposition. Based on the mathematical distances between clinical descriptors, the method 900 may organize, at block 908, the healthcare providers into a plurality of groups. In one embodiment, after the K-means algorithm converges, (e.g., after a stop criteria has been met), final centroids may be calculated for each cluster, and each healthcare provider may be assigned to a centroid that is closest to the healthcare provider's corresponding vector of clinical descriptors.

The method 900 may further include, at block 910, identifying one or more first-level outlier healthcare providers in each of the groups. In one embodiment, a first-level outlier healthcare provider may be a healthcare provider that is beyond a threshold distance from a centroid of the group. For example, if the distance between xᵢ (the vector of clinical descriptors for healthcare provider i) and the centroid μⱼ (centroid of group j to which healthcare provider i belongs) is larger than a threshold, then healthcare provider i may be identified as a first-level outlier healthcare provider. In one embodiment, a threshold for determining an outlier of a cluster may be selected based on the Mahalanobis distance of xᵢ from the centroid of the cluster and the relative tightness of the cluster. For example, if the cluster is densely populated around the centroid, the threshold distance required to identify outliers may be less than a cluster which is not as dense. Afterwards, the method 900 may, at block 912, remove the first-level outlier healthcare providers from the groups to which they belong. FIG. 10 illustrates the result of removing the first-level outlier healthcare providers, as done at block 912. The threshold distance to a centroid may be denoted by a circle 1004. Healthcare providers that are outside the circle 1004 may be identified as first-level outlier healthcare providers 1002.

In one embodiment, the method 900 may include, at block 914, defining a non-clinical descriptors for each healthcare provider, where each non-clinical descriptor may be based on non-clinical information included in the received dataset. The non-clinical descriptor defined at block 914 may be a vector of variables. In one embodiment, defining a non-clinical descriptor may include selecting a number of non-clinical parameters, determining an order for the non-clinical parameters, assigning a value to each non-clinical parameter, and grouping the values into a vector.

At block 916, the method 900 may include evaluating mathematical distances between non-clinical descriptors, and at block 918 the method may include organizing each group of the healthcare providers into a plurality of subgroups. FIG. 11 illustrates the result of organizing each group of the healthcare providers into a plurality of subgroups. After removing the first-level outlier healthcare providers, each group of healthcare providers 1102 (denoted as C′₀, C′₁, C′ₘ) may be grouped into a plurality of subgroups 1104. For example, group C′₀ may be grouped in to subgroups C₀-1, C₀-2, C₀-3, and C₀-4.

The method 900 may further include, at block 920, identifying one or more second-level outlier healthcare providers and, at block 922, removing the second-level outlier healthcare providers from the subgroups to which they belong. In one embodiment, a second-level healthcare provider that is removed from a particular subgroup may remain in the group that contains the particular subgroup. FIG. 12 illustrates the result of removing the second-level outlier healthcare providers from the subgroups to which they belong. In the illustrated embodiment, group 1200 may be grouped into subgroups 1202, 1204, 1206, and 1208. In such an embodiment, healthcare provider 1210 may be identified as an second-level outlier healthcare provider, and may be removed from subgroup 1208. However, healthcare provider 1210 remains in group 1200, which contains subgroup 1208.

In one embodiment, the actions described in blocks 916-922 may be similar to the actions described in blocks 906-912, respectively. In one embodiment, the method 900 may also include, at block 924, presenting clustering results to a user. In a further embodiment, the method 900 may allow a user to input preferences, such as which clustering algorithm to use to generate healthcare provider groups and/or subgroups, how the clustering results is displayed, or the like.

All of the methods disclosed and claimed herein can be made and executed without undue experimentation in light of the present disclosure. While the apparatus and methods of this disclosure have been described in terms of preferred embodiments, it will be apparent to those of skill in the art that variations may be applied to the methods and in the steps or in the sequence of steps of the method described herein without departing from the concept, spirit and scope of the disclosure. In addition, modifications may be made to the disclosed apparatus, and components may be eliminated or substituted for the components described herein where the same or similar results would be achieved. All such similar substitutes and modifications apparent to those skilled in the art are deemed to be within the spirit, scope, and concept of the disclosure as defined by the appended claims.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present processes, disclosure, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A method for deriving healthcare provider groups, the method comprising:
receiving, through a user interface, a dataset for a plurality of healthcare providers, the dataset comprising clinical information for each of the plurality of healthcare providers;
building, by a processor, from the plurality of healthcare providers, a plurality of groups of healthcare providers based on analysis of the received clinical information; and
removing, by the processor, from a particular group of healthcare providers of the plurality of groups one or more healthcare providers determined to be outliers of the particular group.

2. The method of claim 1, in which the dataset further comprises non-clinical information for each of the plurality of healthcare providers, and the method further comprises:
constructing, by the processor, within the plurality of groups of healthcare providers, a plurality of subgroups of healthcare providers based on analysis of the received non-clinical information; and
removing, by the processor, from a particular subgroup of healthcare providers of the plurality of subgroups one or more healthcare providers determined to be outliers of the particular subgroup.

3. The method of claim 2, wherein removing, by the processor, from a particular group of healthcare providers comprises:
identifying one or more first-level outlier healthcare providers from the particular group of healthcare providers, wherein the one or more first-level outlier healthcare providers are of a mathematical distance greater than a threshold from a centroid of the particular group; and
removing the one or more first-level outlier healthcare providers from the particular group.

4. The method of claim 3, wherein removing, by the processor, from a particular subgroup of healthcare providers comprises:
identifying one or more second-level outlier healthcare providers from the particular subgroup of healthcare providers, wherein the one or more second-level outlier healthcare providers are of a mathematical distance greater than a second threshold from a centroid of the particular subgroup; and
removing the one or more second-level outlier healthcare providers from the particular subgroup.

5. The method of claim 4, wherein the second-level outlier healthcare providers removed from the particular subgroup remain in a group of the plurality of groups that contains the particular subgroup.

6. The method of claim 1, further comprising:
defining, by the processor, a clinical descriptor, based on the received clinical information, for each of the plurality of healthcare providers, where each clinical descriptor comprises a vector of one or more variables; and
evaluating, by the processor, one or more mathematical distances between multiple clinical descriptors.

7. The method of claim 1, further comprising:
defining, by the processor, a non-clinical descriptor, based on the received non-clinical information, for each of the plurality of healthcare providers, where each non-clinical descriptor comprises a vector of one or more variables; and
evaluating, by the processor, one or more mathematical distances between multiple non-clinical descriptors.

8. A system for deriving healthcare provider groups, the system comprising:
a data storage device configured to store a dataset for a plurality of healthcare providers, the dataset comprising clinical information for each of the plurality of healthcare providers;
a processor in data communication with the data storage device and configured to:
build, from the plurality of healthcare providers, a plurality of groups of healthcare providers based on analysis of the received clinical information related to medical treatments; and
remove from a particular group of healthcare providers of the plurality of groups one or more healthcare providers determined to be outliers of the particular group.

9. The system of claim 8, in which the data storage device is also configured to store non-clinical information for each of the plurality of healthcare providers, and in which the processor is also configured to:
construct, within the plurality of groups of healthcare providers, a plurality of subgroups of healthcare providers based on analysis of the received non-clinical information related to demographical information; and
remove from a particular subgroup of healthcare providers of the plurality of subgroups one or more healthcare providers determined to be outliers of the particular subgroup.

10. The system of claim 9, wherein the processor is further configured to:
identify one or more first-level outlier healthcare providers from the particular group of healthcare providers, wherein the one or more first-level outlier healthcare providers are of a mathematical distance greater than a threshold from a centroid of the particular group; and
remove the one or more first-level outlier healthcare providers from the particular group.

11. The system of claim 10, wherein the processor is further configured to:
identify one or more second-level outlier healthcare providers from the particular subgroup of healthcare providers, wherein the one or more second-level outlier healthcare providers are of a mathematical distance greater than a second threshold from a centroid of the particular subgroup; and
remove the one or more second-level outlier healthcare providers from the particular subgroup.

12. The system of claim 11, wherein the second-level outlier healthcare providers removed from the particular subgroup remain in a group of the plurality of groups that contains the particular subgroup.

13. The system of claim 8, wherein the processor is further configured to:
define a clinical descriptor, based on the stored clinical information, for each of the plurality of healthcare providers, where each clinical descriptor comprises a vector of one or more variables; and
evaluate one or more mathematical distances between multiple clinical descriptors.

14. The system of claim 8, wherein the processor is further configured to:
define a non-clinical descriptor, based on the stored non-clinical information, for each of the plurality of healthcare providers, where each non-clinical descriptor comprises a vector of one or more variables; and
evaluate one or more mathematical distances between multiple non-clinical descriptors.

15. A computer program product, comprising a non-transitory computer readable medium having computer executable instructions to perform operations comprising:
receiving a dataset for a plurality of healthcare providers, the dataset comprising clinical information for each of the plurality of healthcare providers;
building, from the plurality of healthcare providers, a plurality of groups of healthcare providers based on analysis of the received clinical information related to medical treatments; and
removing from a particular group of healthcare providers of the plurality of groups one or more healthcare providers determined to be outliers of the particular group.

16. The computer program product of claim 15, wherein the dataset further comprises non-clinical information for each of the plurality of healthcare providers, and wherein the medium further comprises instructions to perform operations comprising:
constructing, within the plurality of groups of healthcare providers, a plurality of subgroups of healthcare providers based on analysis of the received non-clinical information related to demographical information; and
removing from a particular subgroup of healthcare providers of the plurality of subgroups one or more healthcare providers determined to be outliers of the particular subgroup.

17. The computer program product of claim 16, wherein the computer executable instructions perform further operations comprising:
identifying one or more first-level outlier healthcare providers from the particular group of healthcare providers, wherein the one or more first-level outlier healthcare providers are of a mathematical distance greater than a first threshold from a centroid of the particular group; and
removing the one or more first-level outlier healthcare providers from the particular group.

18. The computer program product of claim 17, wherein the computer executable instructions perform further operations comprising:
identifying one or more second-level outlier healthcare providers from the particular subgroup of healthcare providers, wherein the one or more second-level outlier healthcare providers are of a mathematical distance greater than a second threshold from a centroid of the particular subgroup; and
removing the one or more second-level outlier healthcare providers from the particular subgroup.

19. The computer program product of claim 18, wherein the second-level outlier healthcare providers removed from the particular subgroup remain in a group of the plurality of groups that contains the particular subgroup.

20. The computer program product of claim 15, wherein the computer executable instructions perform further operations comprising:
defining a clinical descriptor, based on the received clinical information, for each of the plurality of healthcare providers, where each clinical descriptor comprises a vector of one or more variables; and
evaluating one or more mathematical distances between multiple clinical descriptors.

21. The computer program product of claim 15, wherein the computer executable instructions perform further operations comprising:
defining a non-clinical descriptor, based on the received non-clinical information, for each of the plurality of healthcare providers, where each non-clinical descriptor comprises a vector of one or more variables; and
evaluating one or more mathematical distances between multiple non-clinical descriptors.
